(19) United States
(12) Patent Application Publication
(10) Pub. No.: US 2026/0253452 A1
(43) Pub. Date: Aug. 27, 2026

(54) SYSTEMS, DEVICES, AND METHODS FOR DETECTING AND LOCALIZING EDITS IN IMAGES ALTERED BY TEXT-GUIDED DIFFUSION MODELS

(71) Applicant: Reality Defender, Inc., New York, NY (US)

(72) Inventors: Gaurav BHARAJ, Los Angeles, CA (US); Valentina BAZYLEVA, Duivendrecht (NL); Nicolò BONETTINI, Sassuolo (IT)

(73) Assignee: Reality Defender, Inc., New York, NY (US)

(21) Appl. No.: 19/549,737

(22) Filed: Feb. 25, 2026

Related U.S. Application Data
(60) Provisional application No. 63/763,774, filed on Feb. 26, 2025.

(51) Int. Cl. G06V 40/40; G06N 3/0475; G06T 11/60

(52) U.S. Cl. CPC G06V 40/40; G06N 3/0475; G06T 11/60

(57) ABSTRACT

A method for identifying locations of edits in images comprises inputting at least one image into a deepfake detection machine learning model; predicting, using the deepfake detection machine learning model, the location of the one or more edits in the input image; and outputting an indication of the predicted location of the one or more edits in the input image.

### CROSS REFERENCE TO RELATED APPLICATIONS

This application claims the benefit of U.S. Provisional Application No. 63/763,774, filed Feb. 26, 2025, the entire contents of which is incorporated herein by reference.

### FIELD

This disclosure relates generally to machine learning models for deepfake detection, and more specifically to deepfake detection methods for identifying the locations of edits in images.

### BACKGROUND

Rapid advancements in generative models have revolutionized computer vision. One specific application is text-guided image editing (TGIE) using diffusion models, which allows for localized modifications to images based on textual prompts, seamlessly altering content while maintaining photorealism. While these features expand artistic possibilities, they also pose serious problems for media authentication and digital forensics since it gets increasingly challenging to identify and interpret these kinds of modifications. Conventional methods for detecting AI-generated content have focused largely on binary classification, aiming to distinguish between real and synthetic images. However, it is often not enough just to detect whether an image has been manipulated; it is equally important to pinpoint the exact regions where the edits have occurred. Existing detection techniques fail to provide such explainability and thus fail to provide an adequate safety net against the subtle image alterations enabled by TGIE.

### SUMMARY

Disclosed herein are systems, devices, and non-transitory computer readable storage media for detecting diffusion-based TGIE alterations and precisely localizing modified regions of the images using one or more machine learning models, thereby addressing the shortcomings of conventional deepfake detection methods discussed above. Conventional deepfake detection systems have not focused on detecting diffusion-based image modifications that are created using text-guided image editing (TGIE), which enables subtle photo-realistic modification of images without requiring a user specify the exact location and changes to be made. TGIE, however, leaves traces that can be leveraged by machine learning models to effectively localize (e.g., detect the location of) edits in images, as may be done according to the techniques disclosed herein. The deepfake detection model(s) disclosed herein may be trained via self-supervised learning to learn features associated with images that have undergone editing via text-guided image editing. Such features may be indicative of inconsistencies between an edited image and its machine-learning generated reconstruction. These features may be obtained via the inversion of images using a pretrained machine learning model (e.g., a diffusion model) and may be leveraged by the deepfake detection model(s) disclosed herein during both training and inferencing. The deepfake detection model(s) disclosed herein may also be trained (e.g., finetuned) to differentiate between high-frequency regions and low frequency regions in training images, for instance, using a combined segmentation and relevance loss. The segmentation loss may ensure accurate mask prediction by balancing pixel-wise errors and perceptual similarity, while the relevance loss may guide the model to focus on low-frequency regions and mitigate high-frequency artifacts, enhancing the localization of subtle edits.

According to an aspect, an exemplary method for identifying location of edits generated using text-inputs in images comprises: inputting at least one image into a deepfake detection machine learning model, wherein the deepfake detection machine learning model has been trained to identify locations of edits generated using text-inputs in images by: obtaining a plurality of training features corresponding to an edited image using one or more machine learning models; inputting the edited image and the plurality of training features corresponding to the edited image into the deepfake detection machine learning model; predicting a location of one or more edits in the edited image using the deepfake detection machine learning model; comparing the predicted location of the one or more edits to a ground truth location of the one or more edits; and updating the deepfake detection machine learning model based on the comparison; predicting, using the deepfake detection machine learning model, the location of the one or more edits in the input image; and outputting an indication of the predicted location of the one or more edits in the input image.

Optionally, the edited image is obtained by inputting a training image and an edit caption into a deepfake generation model, wherein the deepfake generation model is trained to generate edited images using text-inputs.

Optionally, the deepfake generation model comprises a diffusion model.

Optionally, one or more of the plurality of training features are conditioned on a text-description of the edited image.

Optionally, the one or more edits in the input image were generated using a diffusion model.

Optionally, the at least one image is input into the deepfake detection machine learning model as a concatenated image comprising a plurality of features obtained using a diffusion model.

Optionally, the plurality of features obtained using the diffusion model comprise a decoded noise map.

Optionally, the plurality of features obtained using the diffusion model comprise a reconstructed image generated using the at least one input image.

Optionally, the plurality of features obtained using the diffusion model comprise a reconstruction residual.

Optionally, at least a subset of the plurality of features are conditioned on a text description of the at least one image.

Optionally, the plurality of training features comprise: a decoded noise map, a reconstructed image generated based on the edited image, and a reconstruction residual determined based on the reconstructed image and the edited image.

Optionally, the deepfake detection machine learning model has been finetuned by: training the deepfake detection machine learning model to differentiate between high-frequency regions and low frequency regions in a plurality of training images.

Optionally, the indication of the predicted location of the one or more edits comprises a weighted mask.

Optionally, comparing the predicted location of the one or more edits to a ground truth location of the one or more edits comprises: comparing a predicted image mask representing the predicted location to a ground-truth image mask representing the ground truth location.

Optionally, the ground-truth image mask is determined based on a comparison between a training image and the edited image, wherein the edited image is an edited version of the training image.

Optionally, predicting, using the deepfake detection machine learning model, a location of one or more edits in the input image comprises predicting, for each pixel in the input image, a likelihood that the pixel has been edited.

Optionally, the deepfake detection machine learning model comprises a U-net model architecture.

Optionally, the deepfake detection machine learning model comprises one or more convolutional block attention modules.

Optionally, the one or more machine learning models used to obtain the plurality of training features corresponding to the edited image comprise a diffusion model.

Optionally, the one or more machine learning models comprise a variational autoencoder.

According to an aspect, an exemplary system for identifying location of edits generated using text-inputs in images comprises one or more processors, a memory, and one or more programs, wherein the one or more programs are stored in the memory and configured to be executed by the one or more processors, the one or more programs including instructions for: inputting at least one image into a deepfake detection machine learning model, wherein the deepfake detection machine learning model has been trained to identify locations of edits generated using text-inputs in images by: obtaining a plurality of training features corresponding to an edited image using one or more machine learning models; inputting the edited image and the plurality of training features corresponding to the edited image into the deepfake detection machine learning model; predicting a location of one or more edits in the edited image using the deepfake detection machine learning model; comparing the predicted location of the one or more edits to a ground truth location of the one or more edits; and updating the deepfake detection machine learning model based on the comparison; predicting, using the deepfake detection machine learning model, the location of the one or more edits in the input image; and outputting an indication of the predicted location of the one or more edits in the input image.

According to an aspect, an exemplary non-transitory computer-readable storage medium stores one or more programs for identifying location of edits generated using text-inputs in images, the one or more programs comprising instructions, which when executed by one or more processors of an electronic device, cause the electronic device to: input at least one image into a deepfake detection machine learning model, wherein the deepfake detection machine learning model has been trained to identify locations of edits generated using text-inputs in images by: obtaining a plurality of training features corresponding to an edited image using one or more machine learning models; inputting the edited image and the plurality of training features corresponding to the edited image into the deepfake detection machine learning model; predicting a location of one or more edits in the edited image using the deepfake detection machine learning model; comparing the predicted location of the one or more edits to a ground truth location of the one or more edits; and updating the deepfake detection machine learning model based on the comparison; predict, using the deepfake detection machine learning model, the location of the one or more edits in the input image; and output an indication of the predicted location of the one or more edits in the input image.

According to an aspect, an exemplary method of training a machine learning model to detect locations of edits generated using text-inputs in images comprises: inputting an edited image and a plurality of training features corresponding to the edited image into the machine learning model; predicting a location of one or more edits in the edited image using the machine learning model; comparing the predicted location of the one or more edits to a ground truth location of the one or more edits; and updating the machine learning model based on the comparison.

Optionally, the plurality of training features are obtained using a diffusion model.

Optionally, obtaining the plurality of training features comprises inverting the edited image using the diffusion model.

Optionally, the plurality of training features corresponding to the edited image comprise: an indication of one or more inconsistencies between the edited image and a reconstructed image, wherein the reconstructed image was generated based on the edited image.

Optionally, the indication of the one or more inconsistencies comprises: a decoded noise map, the reconstructed image, and a reconstruction residual determined based on the reconstructed image and the edited image.

Optionally, the method includes finetuning the machine learning model by: training the machine learning model to differentiate between high-frequency regions and low frequency regions in the at least one training image.

Optionally, comparing the predicted location of the one or more edits to a ground truth location of the one or more edits comprises: comparing a predicted image mask representing the predicted location of the one or more edits to a ground-truth image mask representing the ground truth location of the one or more edits.

Optionally, the ground-truth image mask is determined based on a comparison between the original image and the edited image.

Optionally, predicting, using the machine learning model, a location of one or more edits in the input image comprises predicting, for each pixel in the input image, a likelihood that the pixel has been edited.

Optionally, the machine learning model comprises a U-net model architecture.

Optionally, the machine learning model comprises one or more convolutional block attention modules.

Optionally, the edited image and the plurality of training features are input as a concatenated training image.

Optionally, the method includes training the machine learning model using a combined segmentation loss and relevance loss.

According to an aspect, an exemplary system for training a machine learning model to detect locations of edits generated using text-inputs in images comprises one or more processors, a memory, and one or more programs, wherein the one or more programs are stored in the memory and configured to be executed by the one or more processors, the one or more programs including instructions for: inputting an edited image and a plurality of training features corresponding to the edited image into the machine learning model; predicting a location of one or more edits in the edited image using the machine learning model; comparing the predicted location of the one or more edits to a ground truth location of the one or more edits; and updating the machine learning model based on the comparison.

According to an aspect, an exemplary non-transitory computer-readable storage medium stores one or more programs for training a machine learning model to detect locations of edits generated using text-inputs in images, the one or more programs comprising instructions, which when executed by one or more processors of an electronic device, cause the electronic device to: inputting an edited image and a plurality of training features corresponding to the edited image into the machine learning model; predicting a location of one or more edits in the edited image using the machine learning model; comparing the predicted location of the one or more edits to a ground truth location of the one or more edits; and updating the machine learning model based on the comparison.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

The patent or application file contains at least one drawing executed in color. Copies of this patent or patent application publication with color drawing(s) will be provided by the Office upon request and payment of the necessary fee.

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary process for localizing edits in images according to some examples.

FIG. 2 illustrates an exemplary process for training a machine learning model to localize edits in images according to some examples.

FIG. 3 illustrates an exemplary process for extracting training features by inverting using a machine learning model an image according to some examples.

FIG. 4 illustrates an exemplary schematic diagram of a training process for training a machine learning model to localize edits in images according to some examples.

FIG. 5 illustrates a comparison between the predicted location of the edits obtained using the machine learning models disclosed herein and ground truth location of the edits according to some examples.

FIG. 6 illustrates the output of a conventional explainable artificial intelligence deepfake detection model, Grad-CAM, according to some examples.

FIG. 7 illustrates results of edit localization techniques disclosed herein compared to those achievable using other machine learning models according to some examples.

FIG. 8 illustrates the output of the deepfake detection model(s) disclosed herein when provided with an original (unedited) image as the input compared to the output of another machine learning model according to some examples.

FIG. 9 illustrates an exemplary computing device according to some examples.

### DETAILED DESCRIPTION

Disclosed herein are systems, devices, and non-transitory computer readable storage media for detecting diffusion-based text-guided image edits and precisely localizing the modified regions of the images using one or more machine learning models. According to some examples, one or more machine learning models (e.g., “deepfake detection model(s)”) may be trained to detect TGIE-based edits in images and identify the location at which the images have been edited. The deepfake detection model(s) may be trained using edited images and additional features indicative of inconsistencies introduced during the image editing process. The additional features may be obtained using a diffusion model, for instance, during a reverse diffusion, or “inversion,” process. Discrepancies between original latent images and reconstructions thereof are amplified in edited regions. Thus, leveraging features indicative of such discrepancies during training enables the deepfake detection model(s) disclosed herein to effectively localize edits in images.

In some examples, the deepfake detection model(s) disclosed herein are trained via self-supervised learning to learn associations between inversion-induced discrepancies and edited regions. In some examples, one or more features associated with inversion-induced discrepancies are obtained using a machine learning model (e.g., a diffusion model). An edited image and the one or more features may be input into the deepfake detection model to predict the location of one or more edits in the edited image. The predicted location of the one or more edits may be compared to a ground-truth location of the edits, and the model may be updated to train the model to minimize the difference between the predicted location and the ground-truth location. In some examples, the deepfake detection model may be finetuned to further enhance the model's ability to localize edits. The model may be finetuned by directing the model's attention toward the edited regions while reducing the focus on irrelevant background features by directing the model's attention toward low-frequency regions of the images.

During inference, the deepfake detection model(s) may similarly leverage features associated with inversion-induced discrepancies to localize edited regions of images. Images may be fed into the deepfake detection model(s) along with features obtained during inversion (e.g., during a diffusion process), for instance, as a concatenated image, and the deepfake detection model(s) may output an indication of the location of any edits in the image. The output may include an image mask highlighting the edited regions of the image and may be displayed to a user via an interactive user interface. A system implementing the deepfake detection model(s) disclosed herein may execute various downstream actions based on the output of the machine learning model. For instance, the system may remove a detected deepfake from a platform, database, etc., block transmissions, uploads, etc., from a user associated with the image, and/or transmit an alert including the output of the deepfake detection model(s).

In some embodiments, the trained deepfake detection machine learning model(s) may be exposed via an application programming interface (API) to one or more external systems, such as image authentication platforms, social media content moderation systems, digital forensics applications, news media verification services, or other consuming applications. Through the API, these external systems may submit image data and receive, in response, a classification indicating whether the submitted image contains diffusion-based text-guided image editing (TGIE) alterations, a predicted indication (e.g., localization mask) identifying the modified regions within the image, a confidence score, or any combination thereof. The indication (e.g., localization mask) may indicate specific pixel-level or region-level locations of detected edits, enabling precise identification of manipulated areas within the submitted image. Upon detecting TGIE alterations in the submitted image, a system, the trained deepfake detection machine learning model, and/or an external system communicating with the trained deepfake detection machine learning model via the API may trigger responsive actions. Such responsive actions may include blocking or flagging an uploaded image, visually highlighting the localized edited regions within a user interface, inserting a warning indicator or overlay onto the image, generating an alert to a content reviewer, logging a detection event with the associated localization data, quarantining the image for further forensic analysis, or a combination thereof.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

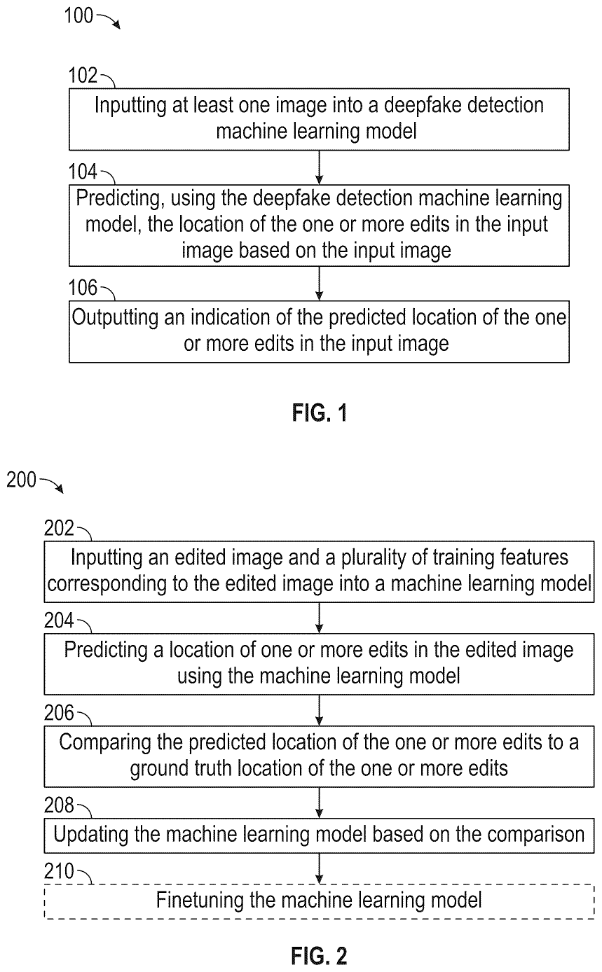

FIG. 1 illustrates aspects of an exemplary process 100 for detecting edits in images, in which the edits were generated using text-inputs (e.g., text-guided image editing). The edits may be detected using one or more machine learning models. The one or more machine learning models may be trained to determine the location at which an image has been edited and may generate an output (e.g., weighted mask, attention map, heat map, etc.) indicating the location of the edits. Process 100 is performed, for example, using one or more electronic devices implementing a software platform. In some examples, process 100 is performed using a client-server system, and the blocks of process 100 are divided up in any manner between the server and a client device. In other examples, the blocks of process 100 are divided up between the server and multiple client devices. Thus, while portions of process 100 may be described herein as being performed by particular devices of a client-server system, it will be appreciated that process 100 is not so limited. In other examples, process 100 is performed using only a client device or only multiple client devices. In process 100, some blocks are, optionally, combined, the order of some blocks is, optionally, changed, and some blocks are, optionally, omitted. In some examples, additional steps may be performed in combination with the process 100. Accordingly, the operations as illustrated (and described in greater detail below) are exemplary by nature and, as such, should not be viewed as limiting.

At block 102, an exemplary system (e.g., one or more electronic devices) inputs at least one image into one or more machine learning models trained to detect the location of edits in images. The at least one input image may have been edited using a deepfake generation machine learning model based on a text-input to the deepfake generation machine learning model. For instance, a user may input a text-instruction to the deepfake generation machine learning model instructing the model to add an object to the image, change a color of an object in the image, etc. The input image may be processed by the deepfake generation machine learning model to alter one or more pixels of the image. The deepfake generation model may include a diffusion model.

In some examples, the at least one image is input into the one or more machine learning models trained to detect the location of edits in images (e.g., deepfake detection model(s)) as a concatenated image comprising a plurality of features associated with the at least one image. The plurality of features concatenated to the at least one image may be obtained using one or more machine learning models (e.g., a variational autoencoder and/or a diffusion model). In some examples the one or more machine learning models used to obtain the plurality of features includes a Stable Diffusion Variational Autoencoder (e.g., including a variational encoder and decoder). The plurality of features associated with the at least one image may be indicative of discrepancies between the at least one input image and its reconstruction. The plurality of features obtained from the one or more machine learning models trained to generate deepfake images may include any one or more of a decoded noise map, a reconstructed image generated using the at least one input image, and a reconstruction residual.

In some examples, one or more of the features included in the concatenated input image are obtained using the equations described below. For instance, an input image x can be encoded into a latent space using a variational autoencoder (VAE) encoder:

$${z}_{0} = V A {E}_{e n c} ( x ) . \qquad ( 1 )$$

DDIM inversion, as described in Jiaming Song, Chenlin Meng, and Stefano Ermon, Denoising Diffusion Implicit Models, arXiv preprint arXiv:2010.02502, (2020), which is incorporated herein by reference in its entirety, can be performed to estimate the initial noise map \hat{z}_{T} that would generate z₀ in the forward diffusion process, conditioned on the CLIP text embedding c of a predicted caption c:

$${\hat{z}}_{T} = DDIMInversion ( {z}_{0} , c ) . \qquad ( 2 )$$

The predicted caption may be a textual description of the image x generated using a machine learning model trained to generate text-descriptions of images. The latent image \hat{z}₀ can be reconstructed from \hat{z}_{T} by a conditional reverse diffusion process. Both \hat{z}_{T} and \hat{z}₀ can be decoded back to the image space by:

$$D ( {\hat{z}}_{T} ) = {VAE}_{dec} \{ {\hat{z}}_{T} ) , D \{ {\hat{z}}_{0} ) = {VAE}_{dec} ( {\hat{z}}_{0} ) . \qquad ( 3 )$$

As shown in George Cazenavette, Avneesh Sud, Thomas Leung, and Ben Usman, Fakeinversion: Learning to detect images from unseen text-to-image models by inverting stable diffusion, Proceedings of the IEEE/CVF Conference on Computer Vision and Pattern Recognition, pages 10759-10769, (2024), which is incorporated herein by reference in its entirety, the inversion process introduces discretization errors δ, causing discrepancies between \hat{z}₀ and z₀ that are informative for detecting edits, as discretization errors are more pronounced in altered regions. The log-likelihood of the data given the underlying model can be approximated in the first order by:

$$log p ( {z}_{0} ) ∝ log {p}_{z} ( {z}_{T} ) - \frac{〈 δ , {\hat{z}}_{0} - {z}_{0} 〉}{{‖ δ ‖}^{2}} . \qquad ( 4 )$$

This relationship indicates that discrepancies between the reconstructed and original latents, especially in regions with edits, lead to a lower log-likelihood. Therefore, analyzing these discrepancies enables detection and localization of edits within images.

The concatenated input to the deepfake detection machine learning model may be obtained by concatenating the image x, the decoded noise map D(\hat{z}_{T}), the reconstructed image D (\hat{z}₀), and the reconstruction residual |x−D(\hat{z}₀)|:

$$ϕ = x ⊕ D ( {\hat{z}}_{T} ) ⊕ D ( {\hat{z}}_{0} ) ⊕ \vert x - D ( {\hat{z}}_{0} ) \vert , \qquad ( 5 )$$

where ⊕ represents the concatenation operation along the channel axis. The concatenated input aims to encapsulate discrepancies that are more prominent in edited regions of the at least one input image.

In some examples, during training, the one or more machine learning models trained to detect the location of edits in images (deepfake detection model(s)) are trained to leverage such discrepancies using a concatenated training image comprising an edited image and a plurality of training features indicative of discrepancies between the edited image and its reconstruction. The training features may obtained using one or more machine learning models, for instance, as described above with reference to equations (1)-(5). One or more edited images may be input into one or more machine learning models (e.g., a variational autoencoder and/or diffusion model, such as the variational encoder/decoder of Stable Diffusion), and a plurality of training features may be obtained using the one or more machine learning models. The plurality of training features may include a decoded noise map, a reconstructed image generated based on the edited image, and a reconstruction residual determined based on the reconstructed image and the edited image.

Training the deepfake detection model(s) to detect the location of edits in images may include inputting the edited image and the plurality of training features corresponding to the edited image into the deepfake detection model(s) and predicting a location of one or more edits in the edited image using the deepfake detection model(s). Predicting the location of one or more edits in the input image may include predicting, for each pixel in the input image, a likelihood that the pixel has been edited. Training the deepfake detection model(s) to detect the location of edits in images may include comparing the predicted location of the one or more edits to a ground truth location of the one or more edits and updating the deepfake detection model(s) based on the comparison. In some examples, the ground truth location of the one or more edits is determined based on a comparison between a training image (e.g., an original image) and the edited image (which may be an edited version of the training/original image). In some examples, the ground truth location of the one or more edits is determined by computing the absolute difference between the training/original image and the edited image. For instance, a ground-truth mask y may be defined as:

$$y = \vert {x}_{o} - {x}_{e} \vert , \qquad ( 6 )$$

where xₒ and xₑ represents the original and edited images respectively. The deepfake detection model(s) be trained to predict a mask ŷ, or any other indication (e.g., heatmap, weighted mask, attention map, etc.), indicating the likelihood of each pixel belonging to an edited area. Comparing the predicted location of the one or more edits to a ground truth location of the one or more edits may include comparing a predicted image mask representing the predicted location to the ground-truth image mask representing the ground truth location.

By learning the association between inversion-induced discrepancies and edited regions, the deepfake detection model(s) effectively localizes edits. Conditioning the inversion on the predicted caption c (e.g., a text-description of the image) amplifies discrepancies when the image content deviates from expectations due to edits. Thus, the deepfake detection model(s) extend inversion-based feature extraction to the task of edit localization by combining discrepancies captured during inversion with a segmentation model. This approach provides a robust method for detecting and precisely localizing edits introduced by diffusion-based text-guided image editing (TGIE) methods.

In some examples, the deepfake detection model(s) are trained (e.g., finetuned) to differentiate between high-frequency regions and low frequency regions in a plurality of training images, further enhancing the deepfake detection model's ability to localize edits. Finetuning the deepfake detection model(s) to differentiate between high-frequency regions and low frequency regions directs the model's attention toward the edited regions while reducing the focus on irrelevant background features. To direct the model's attention, a relevance loss may be incorporated during training/finetuning, encouraging the model's relevance map R(x) to resemble the ground truth mask. Relevance maps may be generated using integrated gradients, as described in Mukund Sundararajan, Ankur Taly, and Qiqi Yan, Axiomatic Attribution for Deep Networks, International conference on machine learning, pages 3319-3328. PMLR, (2017), which is incorporated herein by reference in its entirety, which quantify the contribution of each input pixel to the model's prediction.

High-frequency H(x) and low-frequency L(x) components in the training image(s) may be computed using the Sobel filter to calculate the gradient magnitude of the image, which emphasizes edges and transitions. The Sobel filter computes gradients along the horizontal and vertical directions, capturing changes in pixel intensities. The relevance loss L_{R} may be designed to penalize the model for assigning high relevance to edges while encouraging higher relevance in flat regions. This may be achieved using:

$${ℒ}_{R} = {λ}_{flat} \cdot MSE ( R ( x ) ⊙ L ( x ) , 1 ) + {λ}_{edge} \cdot MSE ( R ( x ) ⊙ H ( x ) , 0 ) , \qquad ( 7 )$$

where λ_{flat} and λ_{edge} are weighting coefficients, and ⊙ is the Hadamard product. The segmentation loss L_{S}, integrating Mean Squared Error (MSE) and Structural Similarity Index Measure (SSIM) losses, for instance, as described in Zhou Wang, Alan C Bovik, Hamid R Sheikh, and Eero P Simoncelli, Image quality assessment: from error visibility to structural similarity, IEEE transactions on image processing, 13(4):600-612, (2004), which is incorporated herein by reference in its entirety, can be defined as:

$${ℒ}_{S} = MSE ( \hat{y} , y ) + α \cdot [ 1 - SSIM ( \hat{y} , y ) ] , \qquad ( 8 )$$

where ŷ represents the model's predicted mask, y is the ground truth mask, and α is a weighting coefficient used to adjust the balance between pixel-wise error and perceptual similarity. The total loss function may be a combination of the segmentation loss and relevance loss, ensuring that the model focuses on both accurate segmentation and attention to the correct regions:

$${ℒ}_{total} = {λ}_{R} \cdot {ℒ}_{R} + {λ}_{S} \cdot {ℒ}_{S} , \qquad ( 9 )$$

where λ_{R} and λ_{S} are weighting coefficients.

At block 104, the deepfake detection model(s) predict the location of the one or more edits in the input image based on the input image. The indication of the predicted location of the one or more edits comprises a mask, weighted mask, attention map, heatmap, or other indication of the predicted location of the one or more edits. At block 106, the exemplary system outputs an indication of the predicted location of the one or more edits in the input image. In some examples, the exemplary system executes an action based on the determination that an image has been edited. For instance, the exemplary system may remove the image from a database, website, or other resource. The exemplary system may block uploads or other transmissions from a user (e.g., of a platform, such as a social media platform, etc.) associated with the deepfake image. The exemplary system may generate and/or transmit an alert based on the detection of the deepfake image. The exemplary alert may include an indication of the predicted location of the edits in the image. Accordingly, the exemplary system implementing process 100 may enable enhanced security against fraud and other malfeasance via explainable detection and/or removal of deepfake images on various platforms, applications, etc. As noted above, in some embodiments, the trained deepfake detection machine learning model may be exposed via an application programming interface (API) to one or more external systems, such as image authentication platforms, social media content moderation systems, digital forensics applications, news media verification services, or other consuming applications. Through the API, these external systems may submit image data and receive, in response, a classification indicating whether the submitted image contains diffusion-based text-guided image editing (TGIE) alterations, a predicted indication (e.g., localization mask) identifying the modified regions within the image, a confidence score, or any combination thereof. The indication (e.g., localization mask) may indicate specific pixel-level or region-level locations of detected edits, enabling precise identification of manipulated areas within the submitted image. Upon detecting TGIE alterations in the submitted image, a system, the trained deepfake detection machine learning model, and/or an external system communicating with the trained deepfake detection machine learning model via the API may trigger responsive actions. Such responsive actions may include blocking or flagging an uploaded image, visually highlighting the localized edited regions within a user interface, inserting a warning indicator or overlay onto the image, generating an alert to a content reviewer, logging a detection event with the associated localization data, quarantining the image for further forensic analysis, or a combination thereof.

The deepfake detection model(s) implemented according to process 100 may include a machine learning model having a U-net model architecture and one or more convolutional block attention modules (CBAM). CBAM enhances feature representation by sequentially applying attention mechanisms along both the channel and spatial dimensions within each convolutional block. Each CBAM block may include a Channel Attention Module and a Spatial Attention Module. The Channel Attention Module emphasizes informative feature channels by computing attention weights across channels using global pooling operations, which are then applied to the feature map. The Spatial Attention Module highlights important spatial regions by computing attention weights across spatial dimensions using pooling operations along the channel axis and applies these weights to the feature map. By integrating CBAM into the U-Net architecture, the model's ability to focus on relevant features both across channels and spatially was improved, enhancing segmentation performance.

FIG. 2 illustrates an exemplary process 200 for training a machine learning model to detect locations of edits generated using text-inputs in images. The machine learning trained according to process 200 may be used, for instance, as the deepfake detection machine learning model implemented in process 100 described above. Process 200 is performed, for example, using one or more electronic devices implementing a software platform. In some examples, process 200 is performed using a client-server system, and the blocks of process 200 are divided up in any manner between the server and a client device. In other examples, the blocks of process 200 are divided up between the server and multiple client devices. Thus, while portions of process 200 may be described herein as being performed by particular devices of a client-server system, it will be appreciated that process 200 is not so limited. In other examples, process 200 is performed using only a client device or only multiple client devices. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

At block 202, an exemplary system (e.g., one or more electronic devices) may input an edited image and a plurality of training features corresponding to the edited image into the machine learning model. The plurality of training features corresponding to the edited image may include an indication of one or more inconsistencies between the edited image and a reconstructed image that was generated based on the edited image. For instance, the indication of the one or more inconsistencies may include a decoded noise map, the reconstructed image, and a reconstruction residual determined based on the reconstructed image and the edited image. The plurality of training features corresponding to the edited image may be obtained by inputting the edited image into one or more machine learning models (e.g., as described with reference to process 100). For instance, an input image x can be encoded into a latent space using a VAE encoder:

$${z}_{0} = {VAE}_{enc} ( x ) .$$

DDIM inversion can be performed to estimate the initial noise map \hat{z}_{T} that would generate z₀ in the forward diffusion process, conditioned on the CLIP text embedding c of a predicted caption c:

$${\hat{z}}_{T} = DDIMInversion ( {z}_{0} , c ) .$$

The predicted caption may be a textual description of the image x generated using a machine learning model trained to generate text-descriptions of images. The latent image \hat{z}₀ can be reconstructed from \hat{z}_{T} by a conditional reverse diffusion process. Both \hat{z}_{T} and \hat{z}₀ can be decoded back to the image space by:

$$D ( {\hat{z}}_{T} ) = {VAE}_{dec} ( {\hat{z}}_{T} ) , D ( {\hat{z}}_{0} ) = {VAE}_{dec} ( {\hat{z}}_{0} ) .$$

The concatenated input to the deepfake detection machine learning model (e.g., during the training process 400 and/or during inference, as described with reference to process 100) may be obtained by concatenating the image x, the decoded noise map D(\hat{z}_{T}), the reconstructed image D(\hat{z}₀), and the reconstruction residual |x−D(\hat{z}₀)|:

$$ϕ = x ⊕ D ( {\hat{z}}_{T} ) ⊕ D ( {\hat{z}}_{0} ) ⊕ \vert x - D ( {\hat{z}}_{0} ) \vert ,$$

where ⊕ represents the concatenation operation along the channel axis.

At block 204, the machine learning model may predict a location of one or more edits in the edited image. The machine learning model make a pixel-wise prediction, indicating a likelihood whether each pixel in the input image has been edited. The machine learning model may predict a mask at block 204, indicating the likelihood of each pixel belonging to an edited area.

At block 206, the exemplary system compares the predicted location of the one or more edits to a ground truth location of the one or more edits. In some examples, the ground truth location of the one or more edits is determined based on a comparison between a training image (e.g., an original image) and the edited image (which may be an edited version of the training/original image). In some examples, the ground truth location of the one or more edits is determined by computing the absolute difference between the training/original image and the edited image. In some examples, comparing the predicted location of the one or more edits to a ground truth location of the one or more edits includes comparing a predicted image mask representing the predicted location to the ground-truth image mask representing the ground truth location.

At block 208, the machine learning model is updated based on the comparison between the predicted location of the one or more edits to a ground truth location of the one or more edits. For instance, the machine learning model may be adjusted to train the model to minimize the difference between the predicted location of the one or more edits to a ground truth location of the one or more edits.

At block 210, the machine learning model is optionally finetuned to differentiate between high-frequency regions and low frequency regions in a plurality of training images, further enhancing the deepfake detection machine learning model's ability to localize edits. As discussed above with reference to process 100, finetuning the deepfake detection machine learning model to differentiate between high-frequency regions and low frequency regions directs the model's attention toward the edited regions while reducing the focus on irrelevant background features. To direct the model's attention, a relevance loss may be incorporated during training/finetuning, encouraging the model's relevance map R(x) to resemble the ground truth mask. Relevance maps may be generated using integrated gradients, which quantify the contribution of each input pixel to the model's prediction.

High-frequency H(x) and low-frequency L(x) components in the training image(s) may be computed using the Sobel filter to calculate the gradient magnitude of the image, which emphasizes edges and transitions. The Sobel filter computes gradients along the horizontal and vertical directions, capturing changes in pixel intensities. The relevance loss L_{R} may be designed to penalize the model for assigning high relevance to edges while encouraging higher relevance in flat regions. This may be achieved using:

$${ℒ}_{R} = {λ}_{flat} \cdot MSE ( R ( x ) ⊙ L ( x ) , 1 ) + {λ}_{edge} \cdot MSE ( R ( x ) ⊙ H ( x ) , 0 ) ,$$

where λ_{flat} and λ_{edge} are weighting coefficients, and ⊙ is the Hadamard product. The segmentation loss L_{S}, integrating Mean Squared Error (MSE) and Structural Similarity Index Measure (SSIM) losses, can be defined as:

$${ℒ}_{S} = MSE ( \hat{y} , y ) + α \cdot [ 1 - SSIM ( \hat{y} , y ) ] ,$$

where ŷ represents the model's predicted mask, y is the ground truth mask, and α is a weighting coefficient used to adjust the balance between pixel-wise error and perceptual similarity. The total loss function may be a combination of the segmentation loss and relevance loss, ensuring that the model focuses on both accurate segmentation and attention to the correct regions:

$${ℒ}_{total} = {λ}_{R} \cdot {ℒ}_{R} + {λ}_{S} \cdot {ℒ}_{S} ,$$

where λ_{R} and λ_{S} are weighting coefficients.

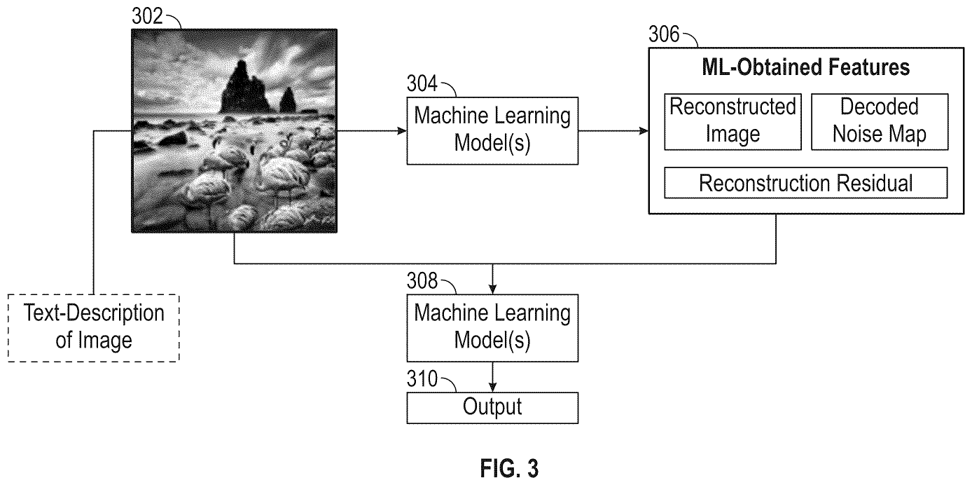

As discussed above, training the deepfake detection model(s) disclosed herein using features indicative of inconsistencies between edited images and their reconstructions enhances the model's ability to localize edits (e.g., diffusion-based edits) in the images. FIG. 3 illustrates a schematic diagram of a process 300 for obtaining features indicating inconsistencies between an edited image and a reconstructed image that was generated based on the edited image. The features can be used to form a concatenated input to a deepfake detection machine learning model during inference and/or training (e.g., as described with reference to FIGS. 1 and 2 above). Any or all aspects of process 300 may be performed during training of the deepfake detection machine learning model described with reference to process 100 and process 200 above.

Process 300 is performed, for example, using one or more electronic devices implementing a software platform. In some examples, process 300 is performed using a client-server system, and the blocks of process 300 are divided up in any manner between the server and a client device. In other examples, the blocks of process 300 are divided up between the server and multiple client devices. Thus, while portions of process 300 may be described herein as being performed by particular devices of a client-server system, it will be appreciated that process 300 is not so limited. In other examples, process 300 is performed using only a client device or only multiple client devices. In process 300, some blocks are, optionally, combined, the order of some blocks is, optionally, changed, and some blocks are, optionally, omitted. In some examples, additional steps may be performed in combination with the process 300. Accordingly, the operations as illustrated (and described in greater detail below) are exemplary by nature and, as such, should not be viewed as limiting.

At block 302, an image is received. The image may have been edited via text-guided image editing (TGIE) methods. At block 304, the image is input into one or more machine learning models. In some examples, a text-description of the image is input into the one or more machine learning models at block 304. The text-description of the image may be obtained using a machine learning model trained to generate textual descriptions of images or may be provided by a human. At block 306, the one or more machine learning models are used to obtain a plurality of features including, for instance, a reconstructed image, a decoded noise map, and a reconstruction residual. The features obtained at block 306 may include any of the features described with reference to FIG. 1 and/or FIG. 2. The features may indicate inconsistencies between an edited image and a reconstructed image introduced by a diffusion process. At block 308, the image received at block 302 and the features obtained using the one or more machine learning models at block 306 may be input into one or more deepfake detection machine learning models at block 308. The image received at block 302 and the features obtained using the one or more machine learning models at block 306 may be used for inferencing and/or for training the one or more machine learning models at block 108, for instance, by performing any or all of the steps described with reference to FIG. 1 and/or FIG. 2. At block 310, the one or more machine learning models from block 308 may generate an output. In some examples, the output may include an indication of a location of one or more edits in the image received at block 302.

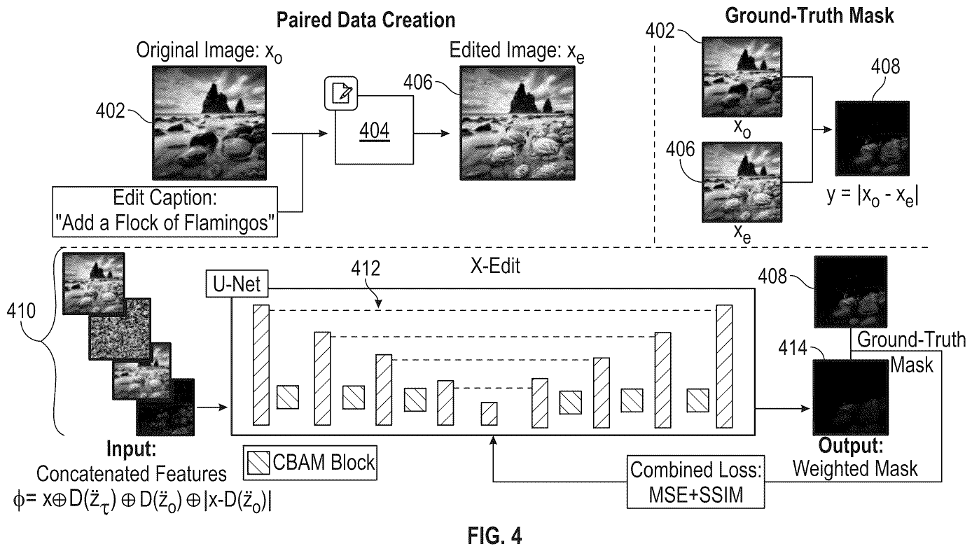

FIG. 4 illustrates a schematic diagram of a process 400 for training one or more machine learning models to detect locations of edits in images. Any or all aspects of process 400 may be performed during process 200 described above. Process 400 is performed, for example, using one or more electronic devices implementing a software platform. In some examples, process 400 is performed using a client-server system, and the blocks of process 400 are divided up in any manner between the server and a client device. In other examples, the blocks of process 400 are divided up between the server and multiple client devices. Thus, while portions of process 400 may be described herein as being performed by particular devices of a client-server system, it will be appreciated that process 400 is not so limited. In other examples, process 400 is performed using only a client device or only multiple client devices. In process 400, some blocks are, optionally, combined, the order of some blocks is, optionally, changed, and some blocks are, optionally, omitted. In some examples, additional steps may be performed in combination with the process 400. Accordingly, the operations as illustrated (and described in greater detail below) are exemplary by nature and, as such, should not be viewed as limiting.

An exemplary system performing process 400 may receive an image 402. The image 402 and a textual edit instruction (e.g., “add a flock of flamingos”) may be input into a machine learning model 404. The machine learning model 404 may be trained to edit images based on textual edit instructions. The machine learning model 404 may generate an edited image 406 using the textual edit instruction and the image 402. For instance, as shown in FIG. 4, the edit instruction is to “add a flock of flamingos” to the image. No flamingos are included in the image 402, but the edited image 406 includes a flock of flamingos. In some examples, one or more additional training features 410 are obtained using the machine learning model 404. In some examples the machine learning model 404 includes a variational autoencoder and/or diffusion model, such as the Stable Diffusion variational autoencoder. The one or more additional training features 410 may include decoded noise, a reconstructed image generated using the edited image 406, and/or a reconstruction residual. As discussed above, the one or more additional features may be indicative of inconsistencies between the edited image 406 and its reconstructions.

The original image 402 and the edited image 406 may be compared to obtain a ground-truth mask 408. The ground truth mask may highlight (e.g., using different colors, pixel intensities, etc.) differences between the original image 402 and the edited image 406. The ground-truth mask 408 may be generated by computing the absolute difference between original image 402 and corresponding edited image 406, as shown in the top right corner of FIG. 4. The edited image 406, one or more additional training features 410, and ground truth mask 408 may be used to train a deepfake detection machine learning model 412. In some examples, the edited image 406 and one or more additional training features 410 are concatenated to form a concatenated input to the deepfake detection machine learning model 412. The deepfake detection machine learning model 412 receives the concatenated input and processes the input via a U-Net architecture with integrated CBAM blocks for enhanced attention to predict locations of one or more edits in the edited image 406. The deepfake detection machine learning model 412 may generate an output mask 414 indicating the locations of one or more edits in edited image 406. In some examples, the output mask 414 may depict pixel-wise predictions indicating whether each pixel in the image has been edited. The output mask 414 may indicate pixels that are predicted to have been edited as lighter, or as a different color, etc., than pixels that are not predicted to have been edited. In some examples, the output mask 414 may highlight regions associated with pixels that are predicted to have been edited (e.g., to increase the visibility of a small number of edited pixels). In some examples, output mask 414 may depict an edited pixel using a first color or intensity and may depict pixels within a threshold distance of the edited pixel using a second color or intensity to indicate those pixels are proximate to an edited pixel. The deepfake detection machine learning model 412 may be updated/trained using a combined loss based on a comparison between the output mask 414 and the ground truth mask 408. The deepfake detection machine learning model 412 may be trained to minimize the difference between the output mask 414 and the ground truth mask 408, highlighting edited regions.

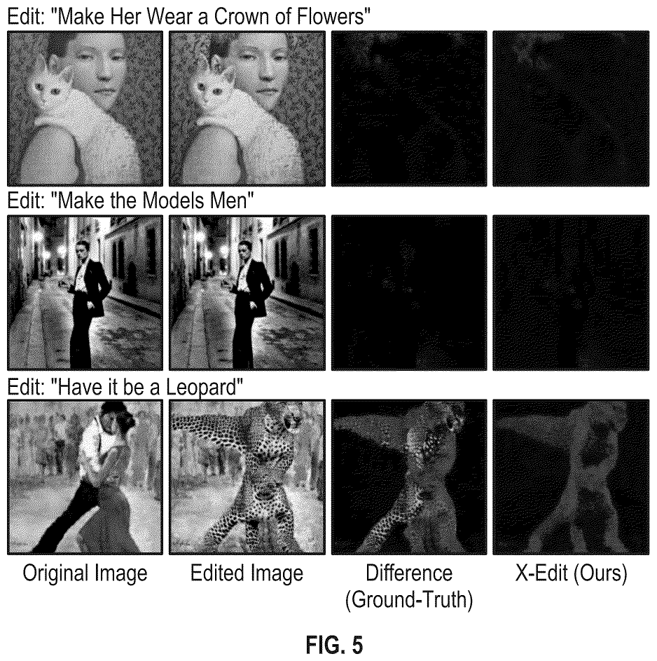

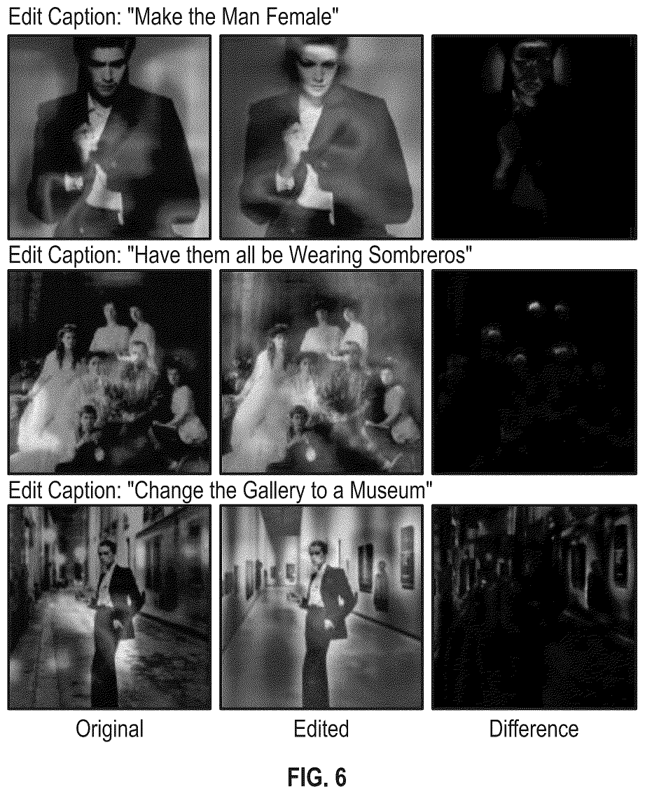

The deepfake detection machine learning model disclosed herein was used to predict locations of edits in a plurality of “test” images. FIG. 5 shows the original image (first column, starting from the far left), the edited image (second column), a mask depicting the ground truth difference between the original image and the edited image (third column), and a mask depicting the predicted location of the edits in the images (fourth column). The edited portions of the image are shown highlighted in the ground truth mask and the mask depicting the predicted location of the edits in the images. Lighter regions correspond to edits and darker regions correspond to portions of the original image that were not edited. As discussed above, in some examples, the deepfake detection models disclosed herein may generate masks highlighting individual pixels deemed likely to have been edited and/or regions associated with likely edits. As shown in FIG. 5, the predicted location of the edits closely aligns with the ground truth illustration of the difference between the original image and the edited image in each case, demonstrating the effectiveness of the deepfake detection machine learning model disclosed herein. FIG. 6 illustrates the output of a conventional explainable artificial intelligence deepfake detection model, Grad-CAM. The first column (far left) of FIG. 6 shows an original image, the second column (middle) shows an edited version of the original image, and the third column (right) shows the ground truth difference between the original and edited images. A heatmap is overlaid on the original image(s) (first column) and the edited image(s) (second column) highlighting the area of the images that contributed most to the Grad-CAM model's prediction regarding whether the image is an original or edited image. Areas highlighted in red and yellow indicate relatively more influence on the Grad-CAM prediction and areas highlighted in blue indicate relatively less influence on the Grad-CAM prediction. FIG. 6 demonstrates how Grad-CAM produces broad relevance maps that struggle to precisely localize edits. For instance, gender alteration (row 1) and the addition of sombreros (row 2) result in diffuse activations rather than alignment with the specific edited areas. This imprecision limits the utility of conventional relevance mapping in forensic tasks, where accurate edit localization is essential. As discussed, the deepfake detection machine learning models disclosed herein enable enhanced accuracy for edit localization relative to existing techniques.

### EXPERIMENTAL IMPLEMENTATION & ANALYSIS EXAMPLES

Comparative analyses were performed between multiple versions of the deepfake detection machine learning model(s) disclosed herein (e.g., a model trained without finetuning on frequency information and a finetuned version trained to differentiate between high-frequency regions and low frequency regions) and between the deepfake detection model(s) disclosed herein and conventional deepfake detection models. The deepfake detection machine learning model(s) disclosed herein are referred to as “X-Edit” and “X-Edit+finetuning” in several instances below. Reference is made below to several variables defined above with reference to equations (1)-(9).

### Input Data Format

Three different input data format configurations were utilized in an experimental analysis of the deepfake detection machine learning model(s) disclosed herein. In the first configuration, φ, the concatenated input as defined in eq. (5) is built using the original image, the inverted image D(\hat{z}_{T}), the reconstructed image D(\hat{z}₀), and the residual error (x−D(\hat{z}₀)), each with 3 color channels (RGB), resulting in a total of 12 channels. The features included in the concatenated input were obtained using a machine learning model as described in Fakeinversion: Learning to detect images from unseen text-to-image models by inverting stable diffusion, Proceedings of the IEEE/CVF Conference on Computer Vision and Pattern Recognition, pages 10759-10769, (2024). For the second configuration, φ_{FI}, the input is simplified to 3 grayscale channels representing the original image, inverted image, and reconstructed image. The third configuration is simply the input image x.

Another machine learning model, xGen-MM (BLIP-3), described in Le Xue, Manli Shu, Anas Awadalla, Jun Wang, An Yan, Senthil Purushwalkam, Honglu Zhou, Viraj Prabhu, Yutong Dai, Michael S Ryoo, et al., xgen-mm (blip3): A family of open large multimodal models, arXiv preprint arXiv:2408.08872, (2024), which is incorporated herein by reference in its entirety, was used to generate captions for the original and edited images, ensuring consistency between the text and image content. Additionally, random augmentations such as horizontal flips, cropping, gaussian blur, and coarse dropout were applied to both images (original and edited), ensuring that the ground truth masks remained accurate post-augmentation. For edited images, the ground truth masks were constructed by computing the absolute difference between the edited image and the original image, for instance, as in eq. (6) discussed above. These masks highlight the edited regions, with non-zero values where modifications have occurred, and served as the target labels for the model to predict. For the original images, the ground truth masks were zero tensors, as no modifications exist.

### Model Architecture

The deepfake detection machine learning model implemented in the experimental implementation included a U-Net architecture augmented with Convolutional Block Attention Modules (CBAM). The input dimension was 512×512. The U-Net was composed by 4 downsampling layers and 4 upsampling layers with skip connections. CBAM enhances feature representation by sequentially applying attention mechanisms along both the channel and spatial dimensions within each convolutional block. Specifically, each CBAM block includes a Channel Attention Module and a Spatial Attention Module. The Channel Attention Module emphasizes informative feature channels by computing attention weights across channels using global pooling operations, which are then applied to the feature map. The Spatial Attention Module highlights important spatial regions by computing attention weights across spatial dimensions using pooling operations along the channel axis and applies these weights to the feature map. By integrating CBAM into the U-Net architecture, the model's ability to focus on relevant features both across channels and spatially was improved, enhancing segmentation performance.

### Comparison Models

No existing state-of-the-art method is trained to detect and localize TGIE, as done by the deepfake detection machine learning models disclosed herein. Thus, to evaluate the effectiveness of the techniques disclosed herein, several other baselines were used. First, a standard U-Net architecture with the same dimensionality as the deepfake detection machine learning model implemented in the experimental implementation was used, but the standard U-Net architecture did not include CBAM modules. Second three ViT based architectures were used, including: a simple ViT-B (input 224×224) trained from scratch, as described in Alexey Dosovitskiy, An image is worth 16×16 words: Transformers for image recognition at scale, arXiv preprint arXiv:2010.11929, (2020), which is incorporated herein by reference in its entirety; the SegFormer model (input 512×512), as described in Enze Xie, Wenhai Wang, Zhiding Yu, Anima Anandkumar, Jose M Alvarez, and Ping Luo, Segformer: Simple and efficient design for semantic segmentation with transformers, Advances in neural information processing systems, 34:12077-12090, (2021), which is incorporated herein by reference in its entirety; and Segment Anything Model (SAM) (input 512×512), as described in Alexander Kirillov, Eric Mintun, Nikhila Ravi, Hanzi Mao, Chloe Rolland, Laura Gustafson, Tete Xiao, Spencer Whitehead, Alexander C Berg, Wan-Yen Lo, et al., Segment anything, Proceedings of the IEEE/CVF International Conference on Computer Vision, pages 4015-4026, (2023), which is incorporated herein by reference in its entirety. SegFormer combines global context capture with efficient multi-scale feature fusion, while SAM is a state-of-the-art segmentation model known for its ability to segment objects in images with high accuracy.

### Inference and Evaluation Metrics

During inference, given a query image x, a caption was generated using BLIP-3 and the feature φ was computes as described in eq. (5) above with reference to FIG. 3. φ is input to the models described above, including the exemplary implementation of the deepfake detection machine learning model disclosed herein (e.g., the model described with reference to FIGS. 1-4) and obtain a mask estimation indicating edits in the image. The models were evaluated using key standard metrics for reconstruction tasks: Peak Signal-to-Noise Ratio (PSNR) and Structural Similarity Index Measure (SSIM) between the predicted mask and the ground-truth mask. The former provides an indication of how faithful the reconstruction task is on a pixel-level, and the latter is useful for evaluating the perceived reconstruction quality.

### Optimization and Finetuning

For optimization, the AdamW optimizer, as described in Ilya Loshchilov, Frank Hutter, et al., Fixing weight decay regularization in adam, arXiv preprint arXiv:1711.05101, 5, (2017), which is incorporated herein by reference in its entirety, was used, with a learning rate of 1×10⁻⁴ and a weight decay of 1×10⁻³. To manage the learning rate schedule, a cosine annealing warm restarts scheduler was used, which adjusted the learning rate dynamically during training. The hyperparameters λ_{flat}, λ_{edge}, λ_{R}, and α were empirically determined to balance the contribution of each loss component: λ_{flat}=0.1, λ_{edge}=3.0, and λ_{R}=λ_{S}=0.5, α=0.2. The constraint λ_{R}+λ_{S}=1 was used to simplify the tuning process and ensure a balanced trade-off between the relevance and segmentation losses.

### Quantitative Results

Table 1 shows quantitative results for the deepfake detection models disclosed herein with respect to the baseline models described above and different network inputs.

TABLE 1
Performance metrics for various models and input types. XEdit
method overperforms baselines both in terms of peak signal-
to-noise (PSNR) and structural similarity index measure (SSIM).
Best result in bold, second best underlined.

| Model | Input | PSNR | SSIM |
|---|---|---|---|
| SAM | x | 23.478 | 0.506 |
| U-Net | x | 24.672 | 0.902 |
| U-Net | φFI | 24.785 | 0.919 |
| ViT-B | φFI | 24.772 | 0.875 |
| SegFormer | φFI | 22.145 | 0.296 |
| X-Edit (ours) | φFI | 24.946 | 0.945 |
| X-Edit (ours) | φ | 24.831 | 0.875 |
| X-Edit + finetuning (ours) | φFI | 24.926 | 0.943 |
| X-Edit + finetuning (ours) | φ | 24.270 | 0.954 |

X-Edit trained on φ_{FI} shows the best PSNR of all the experiments, and the best SSIM is achieved via the finetuning of X-Edit on the complete feature φ. φ is an extension of φ_{FI}, and the finetuning procedure is designed to discourage the network from excessively focusing on high-frequency regions. As a result, X-Edit finetuned on φ produces prediction maps that are perceptually more similar to the ground-truth.

### Qualitative Results

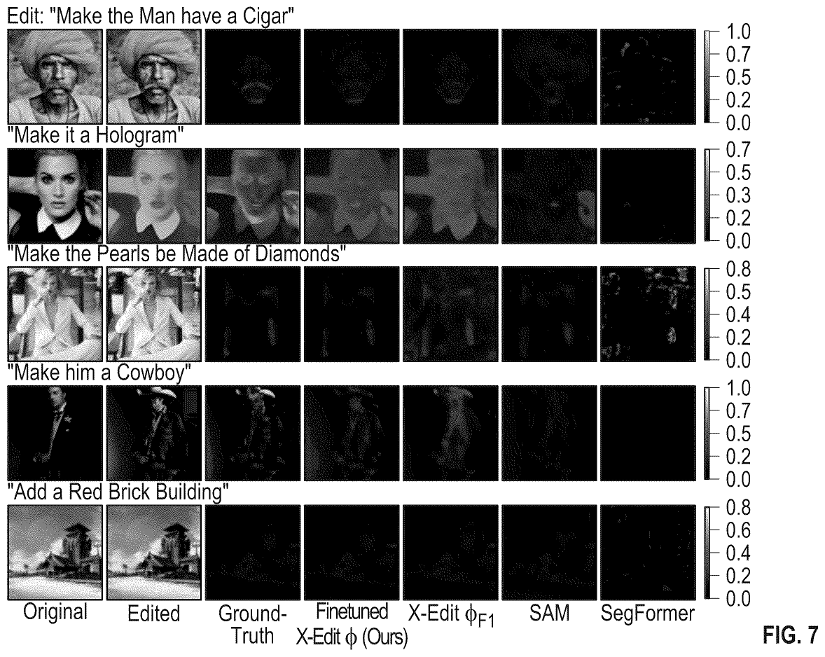

Qualitative results are displayed in FIG. 7. FIG. 7 illustrates, from left to right: an original image, an edited image, a ground truth mask indicating the edited regions, a predicted mask from X-Edit finetuned on φ, a predicted mask from X-Edit on φ_{FI}, a predicted mask from SAM and a predicted mask from SegFormer. X-Edit finetuned on φ (4th column from the left) outperforms the other models by more accurately capturing both the shape and placement of edits, demonstrating finer boundary alignment and better preservation of details in complex regions. This improvement highlights the ability of the deepfake detection machine learning model disclosed herein (“X-Edit”) in maintaining contextual coherence and producing higher-fidelity masks for intricate modifications. As shown in FIG. 7, both the deepfake detection machine learning model finetuned on φ and trained on φ_{FI} effectively highlight edges in edited images, capturing areas where the reconstruction deviates from the original image, which are often located at the transition zones of edits. The techniques disclosed herein enhance the sensitivity to edit-related edges, supporting accurate edit localization and boundary detection. The finetuning adjustments further optimize this sensitivity, allowing the model to refine its focus on edited regions while minimizing background noise in unedited areas.

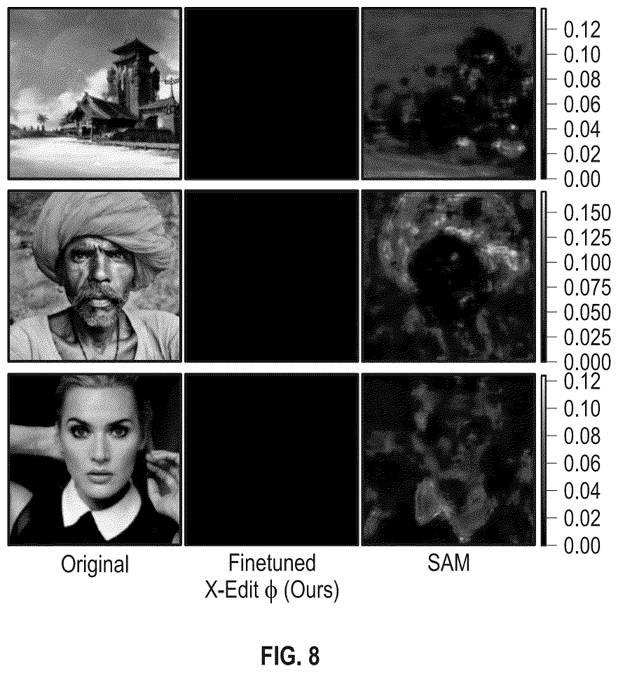

FIG. 8 illustrates how the deepfake detection machine learning models trained according to the techniques disclosed herein can avoid false positives. The first column (left) shows an original image. The second column (middle) illustrates a predicted mask of edit locations generated using the deepfake detection machine learning models disclosed herein (“X-Edit”). As shown, the predicted mask is blank, indicating that the model has correctly predicted that the original image has not been edited. The third column (right) depicts a predicted mask by the SAM model described above, which, as shown, incorrectly predicts that the images have been edited.

### Ablation

In eq. (5), the input φ is defined as the concatenation of an image (e.g., an RGB image), a decoded noise map, a reconstructed image, and the image residual after the DDIM inversion. An ablation study was performed over the input composition. Table 2 shows PSNR and SSIM for the deepfake detection model disclosed herein (X-Edit) fed with various concatenations of partial φ referred to in Table 2 as (A)-(E).

| | Input | PSNR | SSIM |
|---|---|---|---|
| (A) | x | 24.632 | 0.859 |
| (B) | x ⊕ D(\hat{z}_{T}) | 24.535 | 0.837 |
| (C) | x ⊕ D(\hat{z}₀) | 24.677 | 0.894 |
| (D) | x ⊕ D(\hat{z}_{T}) ⊕ D(\hat{z}₀) | 24.709 | 0.889 |
| (E) | x ⊕ D(\hat{z}_{T}) ⊕ \|x − D(\hat{z}₀)\| | 24.576 | 0.893 |
| | φ | 24.831 | 0.875 |

Configuration (A) performs better than (B) despite having less information to exploit, but the addition of D(\hat{z}₀) is beneficial both in terms of PSNR and SSIM. The combination of the two decoded noise map in configuration (D) gives a boost that is unmatched by configuration (E), where the D(\hat{z}₀) is replaced by the residual. The complete feature φ shows better fidelity to the ground-truth according to the PSNR, albeit being less perceptually similar (lower SSIM) than configuration (C), (D) and (E). Despite the slightly lower SSIM, the complete feature φ provides better overall fidelity to the ground truth as indicated by the higher PSNR. Additionally, incorporating all components into φ allows the model to capture a more comprehensive range of discrepancies introduced by edits.

### Exemplary Computing Device

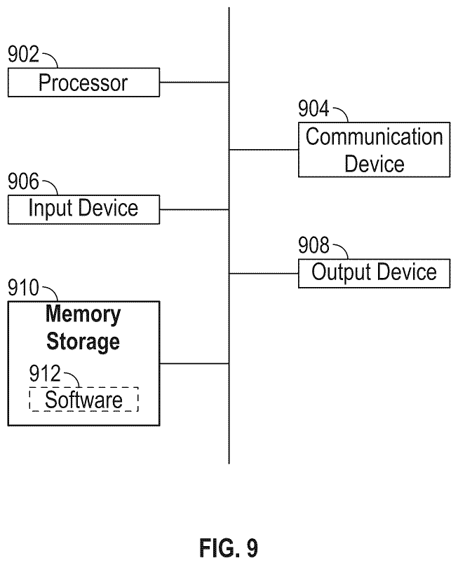

FIG. 9 depicts an exemplary computing device 900, that may be utilized in accordance with one or more examples of the disclosure. Device 900 can be a host computer connected to a network. Device 900 can be a client computer or a server. As shown in FIG. 9, device 900 can be any suitable type of microprocessor-based device, such as a personal computer, workstation, server, or handheld computing device (portable electronic device) such as a phone or tablet. The device can include, for example, one or more of processors 902, input device 906, output device 908, storage 910, and communication device 904. Input device 906 and output device 908 can generally correspond to those described above and can either be connectable or integrated with the computer.

Input device 906 can be any suitable device that provides input, such as a touch screen, keyboard or keypad, mouse, or voice-recognition device. Output device 908 can be any suitable device that provides output, such as a touch screen, haptics device, or speaker.

Storage 910 can be any suitable device that provides storage, such as an electrical, magnetic, or optical memory, including a RAM, cache, hard drive, or removable storage disk. Communication device 904 can include any suitable device capable of transmitting and receiving signals over a network, such as a network interface chip or device. The components of the computer can be connected in any suitable manner, such as via a physical bus or wirelessly.

Software 912, which can be stored in storage 910 and executed by processor 902, can include, for example, the programming that embodies the functionality of the present disclosure (e.g., as embodied in the devices as described above).

Software 912 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 910, that can contain or store programming for use by or in connection with an instruction execution system, apparatus, or device.

Software 912 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 900 can implement any operating system suitable for operating on the network. Software 912 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

### EXAMPLES

1. A method for identifying location of edits generated using text-inputs in images, the method comprising:
   inputting at least one image into a deepfake detection machine learning model, wherein the deepfake detection machine learning model has been trained to identify locations of edits generated using text-inputs in images by:
      obtaining a plurality of training features corresponding to an edited image using one or more machine learning models;
      inputting the edited image and the plurality of training features corresponding to the edited image into the deepfake detection machine learning model;
      predicting a location of one or more edits in the edited image using the deepfake detection machine learning model;
      comparing the predicted location of the one or more edits to a ground truth location of the one or more edits; and
      updating the deepfake detection machine learning model based on the comparison;
   predicting, using the deepfake detection machine learning model, the location of the one or more edits in the input image; and
   outputting an indication of the predicted location of the one or more edits in the input image.
2. The method of example 1, wherein the edited image is obtained by inputting a training image and an edit caption into a deepfake generation model, wherein the deepfake generation model is trained to generate edited images using text-inputs.
3. The method of example 2, wherein the deepfake generation model comprises a diffusion model.
4. The method of any one of examples 1-3, wherein one or more of the plurality of training features are conditioned on a text-description of the edited image.
5. The method of any one of examples 1-3, wherein the one or more edits in the input image were generated using a diffusion model.
6. The method of any one of examples 1-5, wherein the at least one image is input into the deepfake detection machine learning model as a concatenated image comprising a plurality of features obtained using a diffusion model.
7. The method of example 6, wherein the plurality of features obtained using the diffusion model comprise a decoded noise map.
8. The method of any one of examples 6-7, wherein the plurality of features obtained using the diffusion model comprise a reconstructed image generated using the at least one input image.
9. The method of any one of examples 6-8, wherein the plurality of features obtained using the diffusion model comprise a reconstruction residual.
10. The method of any one of examples 6-9, wherein at least a subset of the plurality of features are conditioned on a text description of the at least one image.
11. The method of any one of examples 1-10, wherein the plurality of training features comprise:
   a decoded noise map, a reconstructed image generated based on the edited image, and a reconstruction residual determined based on the reconstructed image and the edited image.
12. The method of any one of examples 1-11, wherein the deepfake detection machine learning model has been finetuned by:
   training the deepfake detection machine learning model to differentiate between high-frequency regions and low frequency regions in a plurality of training images.
13. The method of any one of examples 1-12, wherein the indication of the predicted location of the one or more edits comprises a weighted mask.
14. The method of any one of examples 1-13, wherein comparing the predicted location of the one or more edits to a ground truth location of the one or more edits comprises:
   comparing a predicted image mask representing the predicted location to a ground-truth image mask representing the ground truth location.
15. The method of example 14, wherein the ground-truth image mask is determined based on a comparison between a training image and the edited image, wherein the edited image is an edited version of the training image.
16. The method of any one of examples 1-15, wherein predicting, using the deepfake detection machine learning model, a location of one or more edits in the input image comprises predicting, for each pixel in the input image, a likelihood that the pixel has been edited.
17. The method of any one of examples 1-16, wherein the deepfake detection machine learning model comprises a U-net model architecture.
18. The method of example 17, wherein the deepfake detection machine learning model comprises one or more convolutional block attention modules.
19. The method of any one of examples 1-18, wherein the one or more machine learning models used to obtain the plurality of training features corresponding to the edited image comprise a diffusion model.
20. The method of example 19, wherein the one or more machine learning models comprise a variational autoencoder.
21. A system for identifying location of edits generated using text-inputs in images, the system comprising one or more processors, a memory, and one or more programs, wherein the one or more programs are stored in the memory and configured to be executed by the one or more processors, the one or more programs including instructions for:
   inputting at least one image into a deepfake detection machine learning model, wherein the deepfake detection machine learning model has been trained to identify locations of edits generated using text-inputs in images by:
      obtaining a plurality of training features corresponding to an edited image using one or more machine learning models;
      inputting the edited image and the plurality of training features corresponding to the edited image into the deepfake detection machine learning model;
      predicting a location of one or more edits in the edited image using the deepfake detection machine learning model;
      comparing the predicted location of the one or more edits to a ground truth location of the one or more edits; and
      updating the deepfake detection machine learning model based on the comparison;
   predicting, using the deepfake detection machine learning model, the location of the one or more edits in the input image; and
   outputting an indication of the predicted location of the one or more edits in the input image.
22. A non-transitory computer-readable storage medium storing one or more programs for identifying location of edits generated using text-inputs in images, the one or more programs comprising instructions, which when executed by one or more processors of an electronic device, cause the electronic device to:
   input at least one image into a deepfake detection machine learning model, wherein the deepfake detection machine learning model has been trained to identify locations of edits generated using text-inputs in images by:
      obtaining a plurality of training features corresponding to an edited image using one or more machine learning models;
      inputting the edited image and the plurality of training features corresponding to the edited image into the deepfake detection machine learning model;
      predicting a location of one or more edits in the edited image using the deepfake detection machine learning model;
      comparing the predicted location of the one or more edits to a ground truth location of the one or more edits; and
      updating the deepfake detection machine learning model based on the comparison;
   predict, using the deepfake detection machine learning model, the location of the one or more edits in the input image; and
   output an indication of the predicted location of the one or more edits in the input image.
23. A method of training a machine learning model to detect locations of edits generated using text-inputs in images, the method comprising:
   inputting an edited image and a plurality of training features corresponding to the edited image into the machine learning model;
   predicting a location of one or more edits in the edited image using the machine learning model;
   comparing the predicted location of the one or more edits to a ground truth location of the one or more edits; and
   updating the machine learning model based on the comparison.
24. The method of example 23, wherein the plurality of training features are obtained using a diffusion model.
25. The method of example 24, wherein obtaining the plurality of training features comprises inverting the edited image using the diffusion model.
26. The method of any one of examples 23-25, wherein the plurality of training features corresponding to the edited image comprise:
   an indication of one or more inconsistencies between the edited image and a reconstructed image, wherein the reconstructed image was generated based on the edited image.
27. The method of example 26, wherein the indication of the one or more inconsistencies comprises:
   a decoded noise map, the reconstructed image, and a reconstruction residual determined based on the reconstructed image and the edited image.
28. The method of any one of examples 23-27, further comprising finetuning the machine learning model by:
   training the machine learning model to differentiate between high-frequency regions and low frequency regions in the at least one training image.
29. The method of any one of examples 23-28, wherein comparing the predicted location of the one or more edits to a ground truth location of the one or more edits comprises:
   comparing a predicted image mask representing the predicted location of the one or more edits to a ground-truth image mask representing the ground truth location of the one or more edits.
30. The method of example 29, wherein the ground-truth image mask is determined based on a comparison between the original image and the edited image.
31. The method of any one of examples 23-30, wherein predicting, using the machine learning model, a location of one or more edits in the input image comprises predicting, for each pixel in the input image, a likelihood that the pixel has been edited.
32. The method of any one of examples 23-31, wherein the machine learning model comprises a U-net model architecture.
33. The method of example 32, wherein the machine learning model comprises one or more convolutional block attention modules.
34. The method of any one of examples 23-33, wherein the edited image and the plurality of training features are input as a concatenated training image.
35. The method of any one of examples 23-34, comprising training the machine learning model using a combined segmentation loss and relevance loss.
36. A system for training a machine learning model to detect locations of edits generated using text-inputs in images, the system comprising one or more processors, a memory, and one or more programs, wherein the one or more programs are stored in the memory and configured to be executed by the one or more processors, the one or more programs including instructions for:
   inputting an edited image and a plurality of training features corresponding to the edited image into the machine learning model;
   predicting a location of one or more edits in the edited image using the machine learning model;
   comparing the predicted location of the one or more edits to a ground truth location of the one or more edits; and
   updating the machine learning model based on the comparison.
37. A non-transitory computer-readable storage medium storing one or more programs for training a machine learning model to detect locations of edits generated using text-inputs in images, the one or more programs comprising instructions, which when executed by one or more processors of an electronic device, cause the electronic device to:
   inputting an edited image and a plurality of training features corresponding to the edited image into the machine learning model;
   predicting a location of one or more edits in the edited image using the machine learning model;
   comparing the predicted location of the one or more edits to a ground truth location of the one or more edits; and
   updating the machine learning model based on the comparison.

1. A method for identifying location of edits generated using text-inputs in images, the method comprising:
inputting at least one image into a deepfake detection machine learning model, wherein the deepfake detection machine learning model has been trained to identify locations of edits generated using text-inputs in images by:
obtaining a plurality of training features corresponding to an edited image using one or more machine learning models;
inputting the edited image and the plurality of training features corresponding to the edited image into the deepfake detection machine learning model;
predicting a location of one or more edits in the edited image using the deepfake detection machine learning model;
comparing the predicted location of the one or more edits to a ground truth location of the one or more edits; and
updating the deepfake detection machine learning model based on the comparison;
predicting, using the deepfake detection machine learning model, the location of the one or more edits in the input image; and
outputting an indication of the predicted location of the one or more edits in the input image.

2. The method of claim 1, wherein the edited image is obtained by inputting a training image and an edit caption into a deepfake generation model, wherein the deepfake generation model is trained to generate edited images using text-inputs.

3. The method of claim 2, wherein the deepfake generation model comprises a diffusion model.

4. The method of claim 1, wherein one or more of the plurality of training features are conditioned on a text-description of the edited image.

5. The method of claim 1, wherein the one or more edits in the input image were generated using a diffusion model.

6. The method of claim 1, wherein the at least one image is input into the deepfake detection machine learning model as a concatenated image comprising a plurality of features obtained using a diffusion model.

7. The method of claim 6, wherein the plurality of features obtained using the diffusion model comprise a decoded noise map.

8. The method of claim 6, wherein the plurality of features obtained using the diffusion model comprise a reconstructed image generated using the at least one input image.

9. The method claim 6, wherein the plurality of features obtained using the diffusion model comprise a reconstruction residual.

10. The method of claim 6, wherein at least a subset of the plurality of features are conditioned on a text description of the at least one image.

11. The method of claim 1, wherein the plurality of training features comprise:
a decoded noise map, a reconstructed image generated based on the edited image, and a reconstruction residual determined based on the reconstructed image and the edited image.

12. The method of claim 1, wherein the deepfake detection machine learning model has been finetuned by:
training the deepfake detection machine learning model to differentiate between high-frequency regions and low frequency regions in a plurality of training images.

13. The method of claim 1, wherein the indication of the predicted location of the one or more edits comprises a weighted mask.

14. The method of claim 1, wherein comparing the predicted location of the one or more edits to a ground truth location of the one or more edits comprises:
comparing a predicted image mask representing the predicted location to a ground-truth image mask representing the ground truth location.

15. The method of claim 14, wherein the ground-truth image mask is determined based on a comparison between a training image and the edited image, wherein the edited image is an edited version of the training image.

16. The method of claim 1, wherein predicting, using the deepfake detection machine learning model, a location of one or more edits in the input image comprises predicting, for each pixel in the input image, a likelihood that the pixel has been edited.

17. The method of claim 1, wherein the deepfake detection machine learning model comprises a U-net model architecture.

18. The method of claim 1, wherein the one or more machine learning models used to obtain the plurality of training features corresponding to the edited image comprise a diffusion model.

19. A system for identifying location of edits generated using text-inputs in images, the system comprising one or more processors, a memory, and one or more programs, wherein the one or more programs are stored in the memory and configured to be executed by the one or more processors, the one or more programs including instructions for:
inputting at least one image into a deepfake detection machine learning model, wherein the deepfake detection machine learning model has been trained to identify locations of edits generated using text-inputs in images by:
obtaining a plurality of training features corresponding to an edited image using one or more machine learning models;
inputting the edited image and the plurality of training features corresponding to the edited image into the deepfake detection machine learning model;
predicting a location of one or more edits in the edited image using the deepfake detection machine learning model;
comparing the predicted location of the one or more edits to a ground truth location of the one or more edits; and
updating the deepfake detection machine learning model based on the comparison;
predicting, using the deepfake detection machine learning model, the location of the one or more edits in the input image; and
outputting an indication of the predicted location of the one or more edits in the input image.

20. A non-transitory computer-readable storage medium storing one or more programs for identifying location of edits generated using text-inputs in images, the one or more programs comprising instructions, which when executed by one or more processors of an electronic device, cause the electronic device to:
input at least one image into a deepfake detection machine learning model, wherein the deepfake detection machine learning model has been trained to identify locations of edits generated using text-inputs in images by:
obtaining a plurality of training features corresponding to an edited image using one or more machine learning models;
inputting the edited image and the plurality of training features corresponding to the edited image into the deepfake detection machine learning model;
predicting a location of one or more edits in the edited image using the deepfake detection machine learning model;
comparing the predicted location of the one or more edits to a ground truth location of the one or more edits; and
updating the deepfake detection machine learning model based on the comparison;
predict, using the deepfake detection machine learning model, the location of the one or more edits in the input image; and
output an indication of the predicted location of the one or more edits in the input image.
